(19) United States
(12) Patent Application Publication
(10) Pub. No.: US 2016/0220926 A1
(43) Pub. Date: Aug. 4, 2016

(54) Injector Inlet Fuel Screen

(71) Applicant: Caterpillar Inc., Peoria, IL (US)

(72) Inventor: Diego Caceres, Dunlap, IL (US)

(73) Assignee: Caterpillar Inc., Peoria, IL (US)

(21) Appl. No.: 14/610,269

(22) Filed: Jan. 30, 2015

(51) Int. Cl. B01D 29/11; B01D 35/00

(52) U.S. Cl. CPC B01D 29/112; B01D 35/005

(57) ABSTRACT

An injector inlet fuel screen may include a first annular ring, a second annular ring, and a plurality of support ribs extending axially between and connecting the annular rings. The plurality of support ribs may be circumferentially spaced about the annular rings, and each adjacent pair of support ribs and corresponding portions of the annular rings may define a filter window. At least one of the support ribs may have a generally rectangular cross-section and at least one of the support ribs may have a generally parallelogram-shaped cross-section with no right angles. The fuel screen may further include a plurality of wire mesh panels, with each wire mesh panel overlaying a corresponding one of the filter windows. The injector inlet fuel screen may be installed on a fuel injector case have four inlet ports, with the screen having six support ribs and defining six filter windows.

### TECHNICAL FIELD

The present disclosure relates generally to ring filters and, more particularly, to injector inlet fuel screens configured to ensure that flow paths being filtered by the screens are not obstructed by the screens.

### BACKGROUND

In internal combustion engines, various fluids flow through the engine during operation for different purposes. For example, fuel flows from a fuel source through a fuel injector for discharge into a combustion chamber, and oil flows from an oil source through a control valve and into an area of the engine where the oil provides lubrication between moving parts. Often, the fuel injectors or control valves have hollow cylindrical bodies with radially extending circumferentially spaced fluid inlet ports allowing fluid from the source to enter the interior of the cylindrical body. In many cases, the cylindrical bodies have four circumferentially spaced fluid inlet ports.

In these types of fluid systems, and particularly in fuel injection systems, problems may arise with debris ingestion from the fluid intake side of the system. Debris may come from many sources. Particulate matter may enter the fluid when other components of the system fail, such as fuel pumps or oil pumps. Contamination of the fluid may also occur when components of the system are serviced or replaced. Contaminants may also be present in the fluid due to the machine working environment or fluid storage issues. In some implementations, debris from the fluid may account for a significant portion of total warranty repairs and replacements in a fuel injector family. The primary failures are a consequence of fluid intake side debris plugging the tips of the injectors, and result in reduced power, combustion misfiring and rough idling.

Band or ring type filters for filtering fluid flow through fluid inlet ports in fluid conducting bodies such as fuel injectors and control valves are known in the art. Such a filter is mounted, for example, on the hollow cylindrical member such as the control valve body or the fuel injector body for capturing extraneous materials in the fluid to prevent the inclusion of the extraneous materials into the cylindrical member. One example of such a ring filter for a fuel injector is disclosed in U.S. Pat. No. 5,807,483 to Cassidy et al. that teaches a filter ring including first and second semi-annular, band-shaped filter portions, an integrally formed hinge means for pivotally interconnecting the filter portions, and a snap latch mechanism for detachably connecting the opposite ends of the filter portions. The snap latch mechanism allows the filter ring to be removed without damage, whereupon it may be cleaned and reused many times before requiring replacement. Four semi-annular frames define four filter apertures with strips of filter mesh that correspond to the inlet ports of the fuel injector.

Ring filters of this type include components such as the hinge and the snap latch mechanism that may be prone to failure during the normal use and life of the ring filters, thereby necessitating premature replacement. Moreover, alignment of the ring filter is critical so that the frames do not overlay the inlet ports and obstruct the flow of fluid into the cylindrical body where the number of frames matches the number of inlet ports. Alignment must be assured during installation of the ring filter, which requires additional assembly time, or alignment mechanisms are provided on the cylindrical body and/or the ring filter, which increases the cost of the parts. In view of this, opportunities exist for improved ring filters that are less prone to failure and do not require excessive installation time and effort or additional alignment features to ensure the desired fluid flow through the ring filter.

### SUMMARY OF THE DISCLOSURE

In one aspect of the present disclosure, an injector inlet fuel screen is disclosed. The injector inlet fuel screen may include a first annular ring, a second annular ring, and a plurality of support ribs extending axially between and connecting the first annular ring and the second annular ring. The plurality of support ribs may be circumferentially spaced about the first annular ring and the second annular ring, and each adjacent pair of the plurality of support ribs and corresponding portions of the first annular ring and the second annular ring may define a filter window. At least one of the plurality of support ribs may have a generally rectangular cross-section and at least one of the plurality of support ribs may have a generally parallelogram-shaped cross-section with no right angles. The injector inlet fuel screen may further include a plurality of wire mesh panels, with each wire mesh panel overlaying a corresponding one of the filter windows.

In another aspect of the present disclosure, an injector inlet fuel screen for a cylindrical fluid conducting body having four radially extending fluid inlet ports circumferentially spaced about the fluid conducting body is disclosed. The injector inlet fuel screen may include a first annular ring, a second annular ring, and first, second, third, fourth, fifth and sixth support ribs extending axially between and connecting the first annular ring and the second annular ring. The first, second, third, fourth, fifth and sixth support ribs may be approximately circumferentially spaced about first annular ring and the second annular ring, with the second support rib disposed between the first support rib and the third support rib, the third support rib disposed between the second support rib and the fourth support rib, the fourth support rib disposed between the third support rib and the fifth support rib, the fifth support rib disposed between the fourth support rib and the sixth support rib, the sixth support rib disposed between the first support rib and the fifth support rib. Each adjacent pair of the first, second, third, fourth, fifth and sixth support ribs and corresponding portions of the first annular ring and the second annular ring may define a filter window. The injector inlet fuel screen may further include a plurality of wire mesh panels, with each wire mesh panel overlaying a corresponding one of the filter windows and being retained by the adjacent pair of the first, second, third, fourth, fifth and sixth support ribs and corresponding portions of the first annular ring and the second annular ring defining the filter window.

Additional aspects are defined by the claims of this patent.

### BRIEF DESCRIPTION OF THE DRAWINGS

FIG. 1 is a perspective view of an injector inlet fuel screen in accordance with the present disclosure;

FIG. 2 is a top view of the injector inlet fuel screen of FIG. 1;

FIG. 3 is a front view of the injector inlet fuel screen of FIG. 1;

FIG. 4 is a side view of the injector inlet fuel screen of FIG. 1;

FIG. 5 is a cross-sectional view of the injector inlet fuel screen of FIG. 1 taken through line 5-5 of FIG. 4;

FIG. 6 is a perspective view of the injector inlet fuel screen of FIG. 1 installed on an exemplary fuel injector body;

FIG. 7 is a cross-sectional view of the injector inlet fuel screen and fuel injector body taken through line 7-7 of FIG. 6 with the injector inlet fuel screen in a first position relative to the fuel injector body;

FIG. 8 is the cross-sectional view of the injector inlet fuel screen and fuel injector body of FIG. 7 with the injector inlet fuel screen rotated to a second position relative to the fuel injector body;

FIG. 9 is the cross-sectional view of the injector inlet fuel screen and fuel injector body of FIG. 7 with the injector inlet fuel screen rotated to a third position relative to the fuel injector body; and

FIG. 10 is the cross-sectional view of the injector inlet fuel screen and fuel injector body of FIG. 7 with the injector inlet fuel screen rotated to a fourth position relative to the fuel injector body.

### DETAILED DESCRIPTION

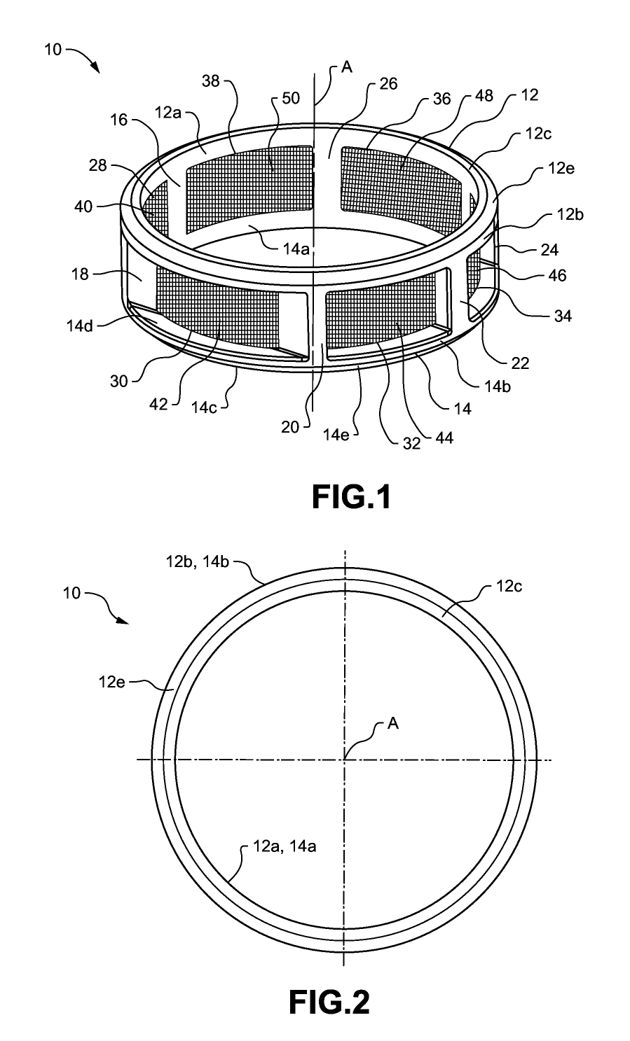

FIG. 1 shows one embodiment of an injector inlet fuel screen 10 in accordance with the present disclosure. The injector inlet fuel screen 10 may be configured to fit over fuel inlet ports of a fuel injector body (not shown) to prevent debris in the fuel from entering the fuel inlet ports as will be described further below. However, application of the fuel screen 10 may not be limited to fuel injectors, and the fuel screen 10 may be configure for use on other types of fluid conducting bodies having cylindrical shapes and fluid inlet ports. The injector inlet fuel screen 10 may have a generally cylindrical form and include a first or upper annular band or ring 12, a second or lower annular band or ring 14 and a plurality of axially-extending support ribs 16, 18, 20, 22, 24, 26 connecting the first ring 12 to the second ring 14. The annular rings 12, 14 may be fabricated from an appropriate resilient material such as nylon with 13% fiberglass reinforcement, or other appropriate materials such as polyurethane, polyethylene, polypropylene that are known in the art. It should be noted that the terms “first,” “second,” “upper,” and “lower” are used for reference and clarity of description of the components of the fuel screen 10 and are not intended to be limiting in the following description.

The annular rings 12, 14 have similar configurations and are centered on a common longitudinal axis A. The first annular ring 12 has cylindrical inner surface 12a, a cylindrical outer surface 12b, an annular outward surface 12c, an annular inward surface 12d and a chamfered or beveled edge 12e between the outer surface 12b and the outward surface 12c. Similarly, the second annular ring 14 has an inner surface 14a, an outer surface 14b, an outward surface 14c, and inward surface 14d and a beveled edge 14e. Referring to the top view of FIG. 2, the inner surfaces 12a, 14a have a constant and equal inner diameter, and the outer surfaces 12b, 14b have a constant and equal outer diameter. With the annular rings 12, 14 axially aligned and configured as shown, the fuel screen 10 is symmetrical about a plane perpendicular to the longitudinal axis A and positioned midway between the annular rings 12, 14.

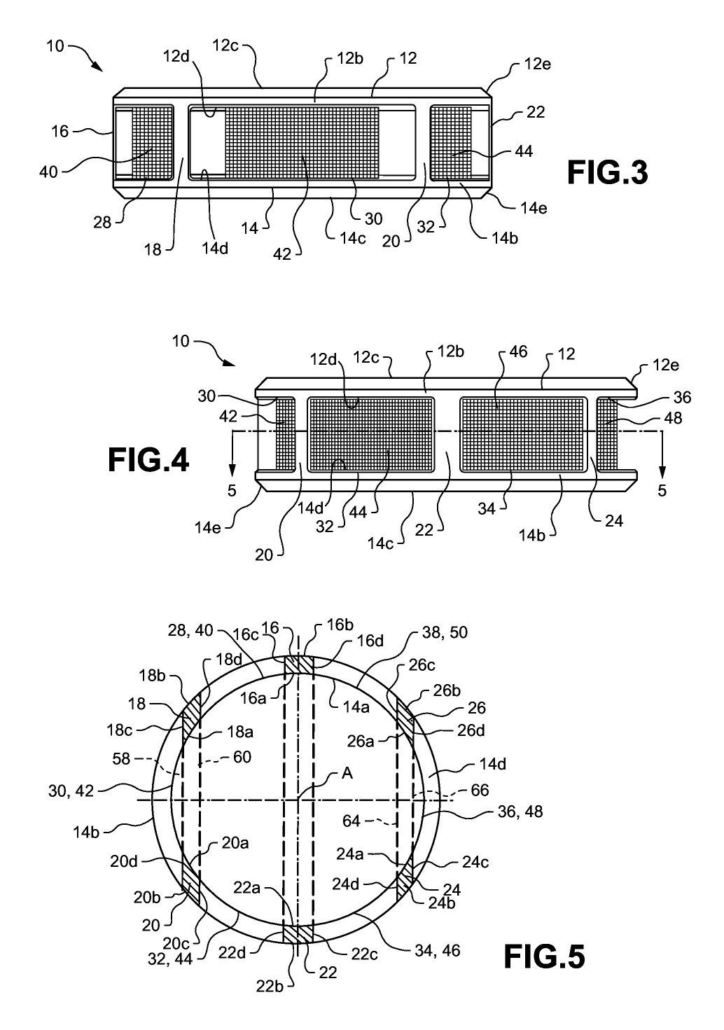

Referring back to FIG. 1, the six support ribs 16, 18, 20, 22, 24, 26 are circumferentially spaced about the annular rings 12, 14. The support ribs 16, 18, 20, 22, 24, 26 are not necessarily evenly spaced about the annular rings 12, 14. Consequently, the adjacent pairs of the support ribs 16, 18, 20, 22, 24, 26 may be circumferentially spaced apart by approximately 60°, or by angles of greater than or less than 60°. Each adjacent pair of the support ribs 16, 18, 20, 22, 24, 26 along with corresponding portions of the inward surfaces 12d, 14d of the annular rings 12, 14, respectively, define a filter window 28, 30, 32, 34, 36, 38 that will allow fluid to flow radially through the fuel screen 10. As the spacing between the supports ribs 16, 18, 20, 22, 24, 26 may vary depending on the exact positioning of the support ribs 16, 18, 20, 22, 24, 26, the widths of the filter windows 28, 30, 32, 34, 36, 38 may not necessarily be equal as may be seen in FIGS. 3 and 4 where the width of the filter windows 30 may be greater than the widths of the filter windows 32, 34.

Wire mesh panels 40, 42, 44, 46, 48, 50 may overlay corresponding filter windows 28, 30, 32, 34, 36, 38 to capture debris in the fluid and prevent the debris from entering the fluid conducting body on which the fuel screen 10 is disposed through the filter windows 28, 30, 32, 34, 36, 38. The wire mesh panels 40, 42, 44, 46, 48, 50 may be portions of a continuous wire mesh band that may be embedded within the annular rings 12, 14 and the support ribs 16, 18, 20, 22, 24, 26, or may be individual wire mesh panels installed within the filter windows 28, 30, 32, 34, 36, 38. These alternatives, as well as alternative fabrication methods for the fuel screen 10 are discussed further below. The wire mesh panels 40, 42, 44, 46, 48, 50 may be fabricated from an appropriate material with appropriately sized openings to capture large debris while allowing the fluid and debris of sufficiently small size as to not pose a significant risk to the performance of the fluid conducting body to flow through the wire mesh. In one implementation, the wire mesh panels 40, 42, 44, 46, 48, 50 may be fabricated from stainless steel wire cloth having mesh openings of approximately 65 microns. Of course, other materials and other mesh openings sizes may be used as dictated by the operating requirements for the fuel screen 10.

The support ribs 16, 18, 20, 22, 24, 26 are configured to reduce the risk and amount of obstruction of the inlet ports of the flow conducting body, and to more effectively direct the flow of fluid to and through the filter windows 28, 30, 32, 34, 36, 38. The cross-sections of the support ribs 16, 18, 20, 22, 24, 26 are shown in greater detail in FIG. 5. The support ribs 16, 22 are positioned diametrically opposite each other and have generally rectangular cross-sections. Inner surface 16a, 22a are flush with the inner surfaces 12a, 14a of the annular rings 12, 14, respectively, and have a slight concave curvature matching the curvature of the inner surfaces 12a, 14a. Outer surfaces 16b, 22b of the support ribs 16, 22 are flush with the outer surfaces 12b, 14b of the annular rings 12, 14, respectively, and have a slight convex curvature matching the curvature of the outer surfaces 12b, 14b. In alternative embodiments, the outer surfaces 16b, 22b, maybe be positioned inwardly or outwardly from the outer surfaces 12b, 14b, and may be generally planar and not match the curvature of the outer surfaces 12b, 14b.

The support ribs 16, 22 further include oppositely disposed lateral surfaces 16c, 16d, 22c, 22d extending between the inner surfaces 16a, 22a and the outer surfaces 16b, 22b. The lateral surfaces 16c, 16d, 22c, 22d may be planar as shown, with the lateral surfaces 16c, 16d of the support rib 16 being parallel to each other and the lateral surfaces 22c, 22d of the support rib 22 being parallel to each other. The lateral surfaces 16c, 16d, 22c, 22d may also be parallel to a diametral line 52 bisecting the support ribs 16, 22 such that the lateral surfaces 16c, 22d are approximately coplanar and the lateral surfaces 16d, 22c are approximately coplanar as indicated by the dashed lines 54, 56, respectively. In alternative embodiments, the support ribs 16, 22 may have cross-sections more closely approximating trapezoids, with the lateral surfaces 16c, 16d, 22c, 22d tapering inwardly or outwardly as they extend from the outer surfaces 16b, 22b toward the inner surfaces 16a, 22a.

The support ribs 18, 20, 24, 26 are distributed on the annular rings 12, 14 with the support ribs 18, 20 disposed on one side of the support ribs 16, 22 and the support ribs 24, 26 disposed on the opposite side of the support ribs 16, 22. The cross-sections of the support ribs 18, 20, 24, 26 are different than the cross-sections of the support ribs 16, 22, and more closely approximate a parallelogram that does not have right angles. As with the support ribs 16, 22, the support ribs 18, 20, 24, 26 have inner surfaces 18a, 20a, 24a, 26a that are flush with the inner surfaces 12a, 14a of the annular rings 12, 14 and slightly concave to match the curvature of the inner surfaces 12a, 14a. Outer surfaces 18b, 20b, 24b, 26b are flush with the outer surfaces 12b, 14b of the annular rings 12, 14 and slightly convex to match the curvature of the outer surfaces 12b, 14b. In alternative embodiments, the outer surfaces 18b, 20b, 24b, 26b maybe be positioned inwardly or outwardly from the outer surfaces 12b, 14b, and may be generally planar and not match the curvature of the outer surfaces 12b, 14b.

The support ribs 18, 20, 24, 26 further include oppositely disposed lateral surfaces 18c, 18d, 20c, 20d, 24c, 24d, 26c, 26d extending between the inner surfaces 18a, 20a, 24a, 26a and the outer surfaces 18b, 20b, 24b, 26b. Similar to the lateral surfaces 16c, 16d, 22c, 22d, the lateral surfaces 18c, 18d, 20c, 20d, 24c, 24d, 26c, 26d may be planar as shown, with the lateral surfaces 18c, 18d, 20c, 20d, 24c, 24d, 26c, 26d of each of the support ribs 18, 20, 24, 26 being parallel to each other. However, because the support ribs 18, 20, 24, 26 approximate parallelograms, the lateral surfaces 18c, 18d, 20c, 20d, 24c, 24d, 26c, 26d are not parallel to diametral lines of the annular rings 12, 14. Instead, the lateral surfaces 18c, 18d, 20c, 20d, 24c, 24d, 26c, 26d of each of the support ribs 18, 20, 24, 26 are angled away from the adjacent support rib 16, 22 and toward the adjacent support rib 18, 20, 24, 26 as the support ribs 18, 20, 24, 26 extend inwardly from the outer surfaces 12b, 14b toward the inner surfaces 12a, 14a. For example, the lateral surfaces 18c, 18d of the support rib 18 are angled away from one adjacent support rib 16 and toward the other adjacent support rib 20. In the illustrated embodiment, the lateral surfaces 18c, 18d, 20c, 20d, 24c, 24d, 26c, 26d are angled to an extent where the support ribs 18, 20 are aligned with the lateral surfaces 18c, 18d being approximately coplanar with the lateral surfaces 20d, 20c, respectively, as indicated by dashed lines 58, 60, and the support ribs 24, 26 are aligned with the lateral surfaces 24c, 24d being approximately coplanar with the lateral surfaces 26d, 26c, respectively, as indicated by dashed lines 62, 64.

### INDUSTRIAL APPLICABILITY

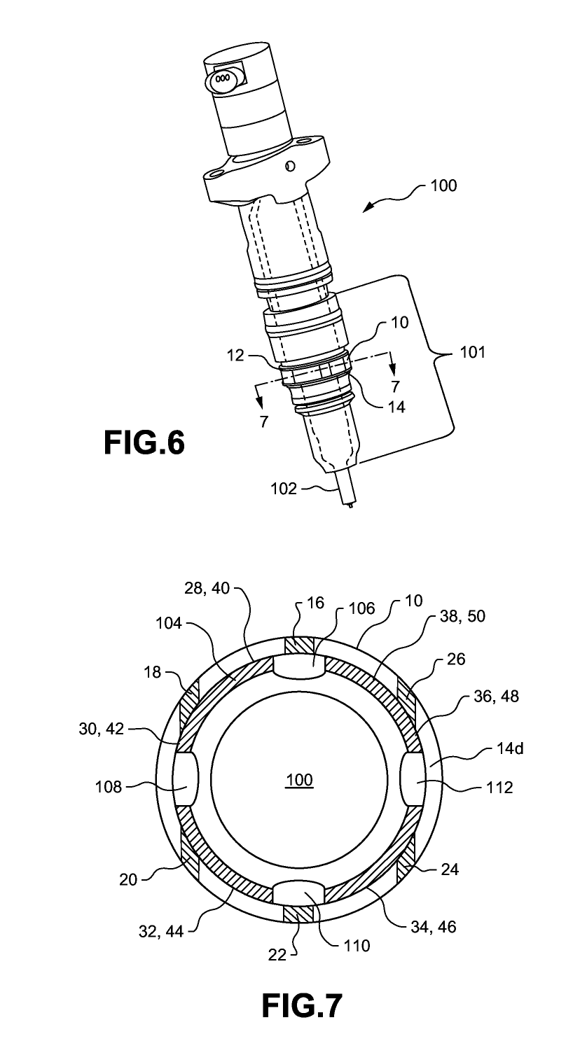

With the configuration illustrated and described herein, the fuel screen 10 does not require precise orientation and alignment to ensure sufficient fluid flow into the inlet ports of a fluid conducting on which the fuel screen 10 is installed. For example, FIG. 6 illustrates the fuel screen 10 installed on a fluid conducting body in the form of a fuel injector nozzle 100 over an injector nozzle case 101. As shown, the fuel screen 10 was installed on the injector nozzle case 101 starting by inserting a tip 102 through the annular ring 12 and sliding the fuel screen 10 all the way up to the portion of the injector nozzle case 101 having the fuel inlet ports (not shown). The fuel inlet ports may extend through an outer surface of the injector nozzle case 101 within an annular groove cavity. As the fuel screen 10 slides up the injector nozzle case 101, the annular rings 12, 14 may pass a section of greater outer diameter than the inner diameter of the fuel screen 10 before reaching the groove cavity and being engaged thereby to prevent substantial axial movement of the fuel screen 10 on the injector nozzle case 101. Depending on the outer diameter of the injector nozzle case 101 within the groove cavity, the fuel screen 10 may fit snuggly in the groove cavity to prevent rotation of the fuel screen 10, or the fuel screen 10 may be able to rotate around the groove cavity when the fuel injector nozzle 100 is operating.

After installation of the fuel screen 10 on the nozzle 100, assembly of the fuel injector may be completed by inserting the injector nozzle case 101 into a fuel injector bore (not shown) of an engine header (not shown). During insertion, the beveled edge 14e of the annular ring 14 may assist in aligning the injector nozzle case 101 within the injector bore. Due to the symmetry of the fuel screen 10, the fuel screen 10 is reversible so that the fuel screen 10 may be flipped and the tip 102 may first be inserted through the annular ring 14 without affecting the functioning of the fuel screen 10 to filter debris from fluids.

In previously known fuel screens and filter rings, the number of the support ribs (4) of the filter ring typically matches the number of fluid inlet ports (4) of the fluid conducting body on which the filter ring is installed. This condition allows for the possibility that each of the support ribs can align with a corresponding one of the fluid inlet ports and thereby significantly reduce the amount of fluid flow into the inlet ports and the fluid conducting body. In some implementations of filter rings, a further alignment mechanism is designed into the filter ring and/or the fluid conducting body to ensure proper alignment of the filter ring without obstructing the inlet ports. In contrast as shown in FIGS. 7-10, the fuel screen 10 in accordance with the present disclosure and including six support ribs 16, 18, 20, 22, 24, 26 minimizes obstruction of the flow paths into the injector nozzle case 101 without the necessity of an additional alignment mechanism.

Referring to the cross-sectional view of FIG. 7, the injector nozzle case 101 may have a generally cylindrical housing 104 having four radially extending fuel inlet ports 106, 108, 110, 112 evenly circumferentially spaced about the housing 104 at the location where the fuel screen 10 is installed. In the orientation of the fuel screen 10 shown in FIG. 7, the diametrically opposite support ribs 16, 22 are aligned with the fuel inlet ports 106, 110 and partially obstruct fuel flow there through. However, at the same time, the filter windows 30, 36 are aligned with the remaining fuel inlet ports 108, 112 and allow fuel to flow into the fuel inlet ports 108, 112 without obstruction.

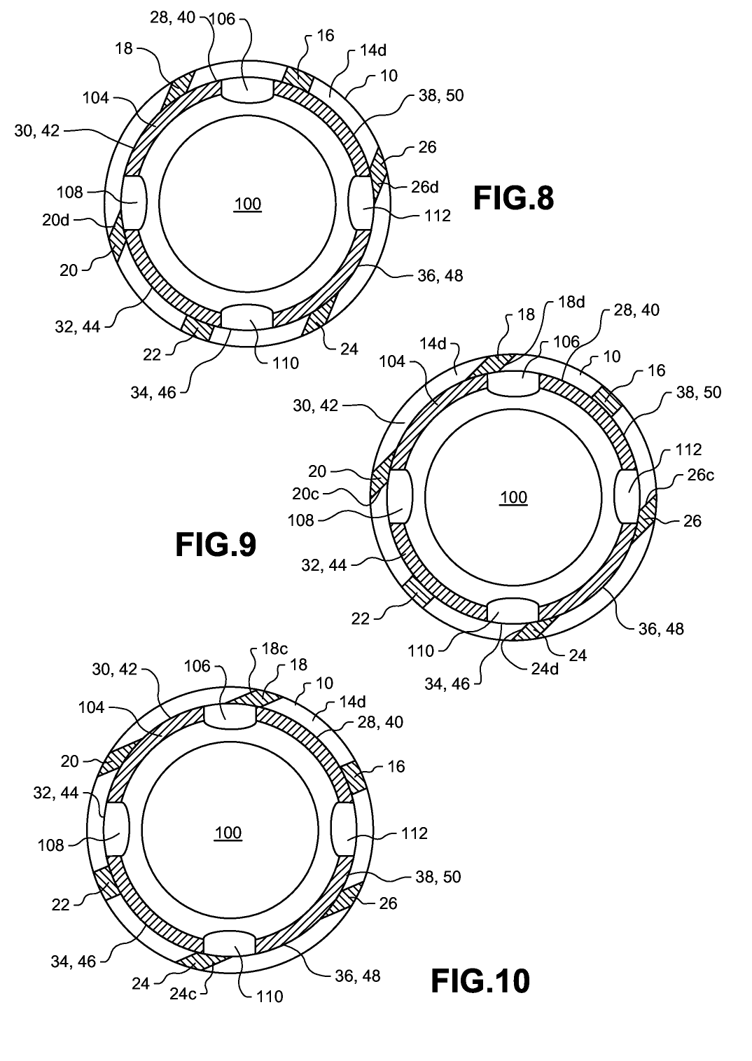

In FIG. 8, the fuel screen 10 is rotated approximately 22.5° relative to the housing 104 of the injector nozzle case 101. In this position, the support ribs 16, 22 are rotated out of alignment with the fuel inlet ports 106, 110, and fuel inlet ports 106, 110 are now aligned with the filter windows 28, 34. At the same time, the support ribs 20, 26 partially overlay the fuel inlet ports 108, 112. Due to the parallelogram cross-sections of the support ribs 20, 26, the angled lateral surfaces 20d, 26d will assist in directing fuel flow into the fuel inlet ports 108, 112 as fuel engages the lateral surfaces 20d, 26d and is guided toward the fuel inlet ports 108, 112.

The fuel screen 10 is rotated an additional approximately 22.5° in the same direction in FIG. 9. In this position, each of the fuel inlet ports 106, 108, 110, 112 is slightly overlaid and obstructed by one of the parallelogram-shaped support ribs 18, 20, 24, 26, respectively. Despite the slight obstruction, the angle of the lateral surfaces 18d, 20c, 24d, 26c may assist in directing fuel flow into the fuel inlet ports 106, 108, 110, 112 so that sufficient fuel reaches the interior of the injector nozzle case 101. An additional rotation of approximately 22.5° is shown in FIG. 10. In this position, the fuel inlet ports 108, 112 are unobstructed and aligned with the filter windows 32, 38, respectively, and the fuel inlet ports 106, 110 are partially obstructed by the support ribs 18, 24 in a similar manner as the fuel inlet ports 108, 112 were partially obstructed by the support ribs 20, 26 in FIG. 8. As can be seen through the series of rotations, the obstruction of the fuel inlet ports 106, 108, 110, 112 is minimized at any position of the fuel screen 10 through the use of a different number of support ribs 16, 18, 20, 22, 24, 26 than fuel inlet ports 106, 108, 110, 112 provided in the fluid conducting body, and by configuring the cross-sections of the support ribs 18, 20, 24, 26 in a manner that promotes fluid flow into the fuel inlet ports 106, 108, 110, 112 when partial obstruction does occur.

The fuel screen 10 may be fabricated using any appropriate manufacturing method. In one alternative fabrication method, the wire mesh panels 40, 42, 44, 46, 48, 50 may be provided by a single continuous wire mesh band embedded within the annular rings 12, 14 and the support ribs 16, 18, 20, 22, 24, 26. After the wire mesh band is formed, the annular rings 12, 14 and the support ribs 16, 18, 20, 22, 24, 26 may be over-molded thereon as a single integral unitary component using a molding process such as injection molding. In an alternative fabrication method, the wire mesh panels 40, 42, 44, 46, 48, 50 may be provided as individual panels configured to cover the filter windows 28, 30, 32, 34, 36, 38, and the annular rings 12, 14 and the support ribs 16, 18, 20, 22, 24, 26 may also be provided as individual components that are assembled with the wire mesh panels 40, 42, 44, 46, 48, 50 engaged thereby and retained within the filter windows 28, 30, 32, 34, 36, 38. Still further, it is also contemplated that three dimensional (3D) printing may develop to the point where the wire mesh band may be provided and the 3D printer will be capable of maneuvering the printing head to deposit the material for the annular rings 12, 14 and the support ribs 16, 18, 20, 22, 24, 26 onto the wire mesh band. Additional fabrication methods will be appreciate by those skilled in the art and are contemplated by the inventor as having use in fabricating fuel screens 10 in accordance with the present disclosure.

While the preceding text sets forth a detailed description of numerous different embodiments, it should be understood that the legal scope of protection is defined by the words of the claims set forth at the end of this patent. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims defining the scope of protection.

It should also be understood that, unless a term was expressly defined herein, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to herein in a manner consistent with a single meaning, that is done for sake of clarity only so as to not confuse the reader, and it is not intended that such claim term be limited, by implication or otherwise, to that single meaning.

What is claimed is:

1. An injector inlet fuel screen, comprising:
a first annular ring;
a second annular ring;
a plurality of support ribs extending axially between and connecting the first annular ring and the second annular ring, wherein the plurality of support ribs are circumferentially spaced about the first annular ring and the second annular ring, wherein each adjacent pair of the plurality of support ribs and corresponding portions of the first annular ring and the second annular ring define a filter window, and wherein at least one of the plurality of support ribs has a generally rectangular cross-section and at least one of the plurality of support ribs has a generally parallelogram-shaped cross-section with no right angles; and
a plurality of wire mesh panels, with each wire mesh panel overlaying a corresponding one of the filter windows.

2. The injector inlet fuel screen of claim 1, wherein the at least one of the plurality of support ribs having a generally rectangular cross-section comprises a first rectangular support rib and a second rectangular support rib disposed diametrically opposite the first rectangular support rib on the first annular ring and the second annular ring.

3. The injector inlet fuel screen of claim 2, wherein each of the first rectangular support rib and the second rectangular support rib comprises an inner surface disposed proximate inner surfaces of the first annular ring and the second annular ring, an outer surface disposed proximate outer surfaces of the first annular ring and the second annular ring, a first lateral surface and an oppositely disposed second lateral surface extending from the outer surface to the inner surface, wherein the first lateral surface of the first rectangular support rib is coplanar with the second lateral surface of the second rectangular support rib, and the second lateral surface of the first rectangular support rib is coplanar with the first lateral surface of the second rectangular support rib.

4. The injector inlet fuel screen of claim 1, wherein the at least one of the plurality of support ribs having a generally parallelogram-shaped cross-section comprises a first parallelogram support rib and a second parallelogram support rib disposed adjacent the first parallelogram support rib on the first annular ring and the second annular ring.

5. The injector inlet fuel screen of claim 4, wherein each of the first parallelogram support rib and the second parallelogram support rib comprises an inner surface disposed proximate inner surfaces of the first annular ring and the second annular ring, an outer surface disposed proximate outer surfaces of the first annular ring and the second annular ring, a first lateral surface and an oppositely disposed second lateral surface extending from the outer surface to the inner surface, wherein the first lateral surface is parallel to the second lateral surface.

6. The injector inlet fuel screen of claim 5, wherein the first lateral surface and the second lateral surface of the first parallelogram support rib are parallel to the first lateral surface and the second lateral surface of the second parallelogram support rib.

7. The injector inlet fuel screen of claim 5, wherein the first lateral surface of the first parallelogram support rib is coplanar with the second lateral surface of the second parallelogram support rib, and the second lateral surface of the first parallelogram support rib is coplanar with the first lateral surface of the second parallelogram support rib.

8. The injector inlet fuel screen of claim 1, wherein the at least one of the plurality of support ribs having a generally rectangular cross-section comprises:
a first rectangular support rib, and
a second rectangular support rib disposed diametrically opposite the first rectangular support rib on the first annular ring and the second annular ring; and
wherein the at least one of the plurality of support ribs having a generally parallelogram-shaped cross-section comprises:
a first parallelogram support rib disposed adjacent the first rectangular support rib,
a second parallelogram support rib disposed between the first parallelogram support rib and the second rectangular support rib,
a third parallelogram support rib disposed adjacent the first rectangular support rib with the first rectangular support rib disposed between the first parallelogram support rib and the third parallelogram support rib, and
a fourth parallelogram support rib disposed between the third parallelogram support rib and the second rectangular support rib.

9. The injector inlet fuel screen of claim 8, wherein each of the first, second, third and fourth parallelogram support ribs comprises an inner surface disposed proximate inner surfaces of the first annular ring and the second annular ring, an outer surface disposed proximate outer surfaces of the first annular ring and the second annular ring, a first lateral surface and an oppositely disposed second lateral surface extending from the outer surface to the inner surface, wherein the first lateral surface is parallel to the second lateral surface and wherein the first lateral surface and the second lateral surface extend away from the adjacent one of the first rectangular support rib and the second rectangular support rib.

10. The injector inlet fuel screen of claim 1, comprising a cylindrical wire mesh band embedded in the first annular ring, the second annular ring and the plurality of support ribs, wherein the plurality of wire mesh panels are portions of the wire mesh band that are exposed by the corresponding filter windows.

11. An injector inlet fuel screen for a cylindrical fluid conducting body having four radially extending fluid inlet ports circumferentially spaced about the fluid conducting body, the injector inlet fuel screen comprising:
a first annular ring;
a second annular ring;
first, second, third, fourth, fifth and sixth support ribs extending axially between and connecting the first annular ring and the second annular ring, wherein the first, second, third, fourth, fifth and sixth support ribs are approximately circumferentially spaced about first annular ring and the second annular ring, with the second support rib disposed between the first support rib and the third support rib, the third support rib disposed between the second support rib and the fourth support rib, the fourth support rib disposed between the third support rib and the fifth support rib, the fifth support rib disposed between the fourth support rib and the sixth support rib, the sixth support rib disposed between the first support rib and the fifth support rib, wherein each adjacent pair of the first, second, third, fourth, fifth and sixth support ribs and corresponding portions of the first annular ring and the second annular ring define a filter window; and
a plurality of wire mesh panels, with each wire mesh panel overlaying a corresponding one of the filter windows and being retained by the adjacent pair of the first, second, third, fourth, fifth and sixth support ribs and corresponding portions of the first annular ring and the second annular ring defining the filter window.

12. The injector inlet fuel screen of claim 11, wherein each of the first, second, third, fourth, fifth and sixth support ribs comprises an inner surface disposed proximate inner surfaces of the first annular ring and the second annular ring, an outer surface disposed proximate outer surfaces of the first annular ring and the second annular ring, a first lateral surface and an oppositely disposed second lateral surface extending from the outer surface to the inner surface of the support rib, wherein the first lateral surface is parallel to the second lateral surface.

13. The injector inlet fuel screen of claim 12, wherein the first support rib and the fourth support rib have generally rectangular cross-sections.

14. The injector inlet fuel screen of claim 13, wherein the first lateral surface of the first support rib is coplanar with the second lateral surface of the fourth support rib, and the second lateral surface of the first support rib is coplanar with the first lateral surface of the fourth support rib.

15. The injector inlet fuel screen of claim 11, wherein the second, third, fifth and sixth support ribs each have generally parallelogram-shaped cross-section without right angles.

16. The injector inlet fuel screen of claim 15, wherein the first lateral surfaces and the second lateral surfaces of the second and sixth support ribs extend away from the first support rib as the first lateral surfaces and the second lateral surfaces extend from the outer surfaces toward the inner surfaces, and wherein the first lateral surfaces and the second lateral surfaces of the third and fifth support ribs extend away from the fourth support rib as the first lateral surfaces and the second lateral surfaces extend from the outer surfaces toward the inner surfaces.

17. The injector inlet fuel screen of claim 15, wherein the first lateral surfaces and the second lateral surfaces of the second and third support ribs are parallel, and the first lateral surfaces and the second lateral surfaces of the fifth and sixth support ribs are parallel.

18. The injector inlet fuel screen of claim 15, wherein the first lateral surface of the second support rib is coplanar with the second lateral surface of the third support rib, the second lateral surface of the second support rib is coplanar with the first lateral surface of the third support rib, the first lateral surface of the fifth support rib is coplanar with the second lateral surface of the sixth support rib, and the second lateral surface of the fifth support rib is coplanar with the first lateral surface of the sixth support rib.

19. The injector inlet fuel screen of claim 11, wherein the injector inlet fuel screen is symmetrical about a plane perpendicular to a common longitudinal axis of the first annular ring and the second annular ring and bisecting the injector inlet fuel screen.

20. The injector inlet fuel screen of claim 11, comprising a cylindrical wire mesh band embedded in the first annular ring, the second annular ring and the first, second, third, fourth, fifth and sixth support ribs, wherein the plurality of wire mesh panels are portions of the wire mesh band that are exposed by the corresponding filter windows.
